(19) United States
(12) Patent Application Publication
(10) Pub. No.: US 2023/0014953 A1
(43) Pub. Date: Jan. 19, 2023

(54) METHOD FOR MODIFYING A MESSAGE IN A SMS FORMAT BY INCLUDING A PERSONALIZED ADVERTISING CONTENT THEREIN AND A SYSTEM FOR PERFORMING THE SAME

(71) Applicant: GLOBAL MESSAGE SERVICES AG, Baar (CH)

(72) Inventors: Iurii Mykolaiovych MAKARENKO, Risch (CH); Illia Davydovych SOLODOVSKYI, Unterägeri (CH); Volodymyr Volodymyrovych GERNESHII, London (GB)

(73) Assignee: GLOBAL MESSAGE SERVICES AG, Baar (CH)

(21) Appl. No.: 17/578,045

(22) Filed: Jan. 18, 2022

(30) Foreign Application Priority Data
Jul. 15, 2021 (UA) A 2021 04113

(51) Int. Cl. G06Q 30/02; G06F 9/54; G06Q 30/04

(52) U.S. Cl. CPC G06Q 30/0271; G06F 9/547; G06Q 30/04

(57) ABSTRACT

Methods and systems are provided for modifying a message in a SMS format by including a personalized advertising content therein. The technical solution enables enterprises, mobile operators, and HUBs which send a transactional A2P SMS traffic to their end users to add personalized advertising materials, such as a text, an active URL address that forward to personalized microsites, a phone number or a short phone number etc., to an original text of the SMS message. The methods and systems provided also enable advertisers to integrate and to automatically distribute the advertising content by SMS message by means of a real-time bidding (RTB) technology based on preliminary established advertisement targeting criteria and a number of non-used characters.

### CROSS REFERENCE TO RELATED APPLICATION

This application claims the benefit of Ukraine Patent Application No. a 2021 04113, filed Jul. 15, 2021 the contents of which are incorporated by reference herein in its entirety.

### FIELD OF THE INVENTION

The group of inventions relates to a field of information services exchange in mobile communication systems, namely, to a technology for adding an advertising information to short messages, which are forwarded to phone users.

### BACKGROUND

### Terms Used in the Description Text of the Group of Inventions

SMS (Short Message Service) is a short messages system, which is a service for exchanging short text messages within telecommunication networks. In order to be implemented, the service must be supported by a communication provider, a communication device, and a software of the communication device. In case of mobile communication, a SIM (USIM) card is necessary to use the service. The technology of SMS messages is supported by GSM, D-AMPS, CDMA, UMTS mobile networks.

SMS center (SMSC, Short Message Service Center) is responsible for operation of the short message service of the mobile communication network. The SMS message transmitted from a mobile phone will be firstly received by the SMS center, and then it will be forwarded to a recipient. The main function of the SMS center is to route messages and to operate the delivery process.

SIM card (Subscriber Identification Module) is an identification module of a subscriber in the form of a smart card that is used in the mobile communication (a mobile phone, a smart phone, a modem, and other subscriber equipment devices). The card identification is performed by means of an algorithm and a secret code, which are written on it. The card also serves to decipher a voice and telecommunication signals, as well as to store an additional information, in particular, phone numbers and/or SMS messages.

USIM card (Universal Subscriber Identity Module) is an extended standard of the SIM card that is approved within the LTE (Long Term Evolution) being a European standard of a 4th generation mobile communication (4G).

GSM (Global System for Mobile Communications) is a global system for the mobile communication being an international standard for the mobile digital cellular communication.

D-AMPS (Digital Advanced Mobile Phone System) is a digital system of a second generation cellular communication (2G). This standard has gained a widespread use in the Northern America, mostly in USA and Canada.

CDMA (Code Division Multiple Access) is one or possible multiplexing technologies, i.e. technologies for simultaneous data transmission in a shared range (a so called channel) of radio frequencies. In order to enable access to the channel by multiple users, the data is encoded with a special code that is associated with each channel, and properties of a constructive interference of special codes are used in order to perform the multiplexing.

UMTS (Universal Mobile Telecommunications System) is a cellular communication technology developed by the European Telecommunications Standards Institute (ETSI) to implement 3G in Europe. Also, the UMTS is often called as 3 GSM in order to emphasize pertaining of the technology to the 3G networks and its heredity in developing networks of the GSM standard.

SMPP (Short message peer-to-peer protocol) is protocol that allows “external” devices to exchange messages with the PLMN mobile network by means of the SMS center (SMSC).

PLMN (Public land mobile network) is a coverage area of the mobile network that is a combination of all cells of a single operator of the communication network. An example could be a network of the NMT, GSM, UMTS, IS-95 (network CDMA), PDC standard.

DCS (Data Coding Scheme) is a scheme for coding a text of the SMS message.

A2P SMS messages (Application-to-person SMS) are messages, which are generated by a company and sent to an end user.

Enterprise is an enterprise, company, corporation that generates the A2P traffic.

A2P Traffic is the A2P traffic of the SMS messages that is formed at the side of the corporation (or mobile operator) and, according to the described group of inventions, transmitted to a message modification system in the SMS format to be added to the advertising text.

Advertising materials (ad-tails) are advertising messages, which, according to the described group of inventions, consist of a personalized text message and a URL address that forwards to a personalized microsite or a web-site mobile version, a phone number, a short phone number etc.

Transactional A2P messages are all SMS messages, which are not advertising ones. For example, one-time passwords or SMS notifications regarding delivery etc.

End recipient (Subscriber) is a subscriber of the cellular communication that is able to receive and to read the SMS message.

An advertiser (Advertiser) is a company that provides the advertising materials and is interested in positioning these advertising materials in the transactional A2P SMS messages.

Web (WEB) is a system for accessing documents and files associated between each other on various computers coupled to the network.

A site is any hardware and software complex that provides services or information (including a bidirectional information exchange) according to the WEB technology or another technology in the network. It is one or several pages (usually web-pages) associated between each other, as well as a location of a server content. Usually, the site in the network is an array of associated data having a unique address and perceived as an integral unit by a user. The site enables both to display the information and to receive the same from the user for further processing, which could result in a change of the information being displayed.

A mobile microsite is a mobile version of the site that consists of a single page, comprises a text of an informational or advertising nature, media materials (pictures, animated pictures, video etc.), questionnaires, as well as active buttons and links.

HTTP (Hypertext Transfer Protocol) is a data transmission protocol that is used in computer networks.

A data transmission protocol (hereinafter referred to as the protocol) is a set of agreements of a logical level interface that define the data exchange between various programs. These agreements provide a uniform method for transmitting messages and processing errors during interaction of the software of the spatially distributed equipment that is coupled by a certain interface.

URL (Uniform Resource Locator, a unified locator or address of a resource) is a standardized address of a certain resource (such as a document or an image) in the Internet (or elsewhere).

A network (a computing network, a computer network) is a system that enables the data exchange between computing devices (computers, servers, routers, and other equipment). Various media may be used for the information transmission. Internet, Intranet are examples of the network.

Internet is a worldwide system of combined computer networks for storing, processing, and transmitting the information.

On-line is a state of connection to the network that enables to participate in its operation.

Data is a presentation of the information in a formalized form that is suitable for the transmission, communication or processing, which are operated by information systems and users thereof, to be multiply interpreted.

A hub (HUB) is a node of any network in a general meaning. In the described technical solution, the hub is a company that sends the traffic from other clients in transit.

RTB (Real-time-bidding) is a technology in the on-line advertisement industry that is a real-time advertisement bidding and utilizes the IAB OpenRTB protocol. The RTB participants are:
SSP (Supply Side Platform) that is an advertising network that acts as a seller and provides places for showing the advertisement in the bidding;
DSP (Demand Side Platform) that is an advertising network that acts as a buyer of the advertisement place and provides the advertisement being video, banners etc. to the bidding;
DMP (Data Management Platform) that is a provider of a data about users; Agency Trading Desk that is a platform that helps advertisers to buy large volumes of an audience in digital mass media in a more effective way;
Publisher is a site owner.

A click rating or a click-through rate CTR is a ratio between a number of clicks to a link and a number of its impressions. It is measured in percent. It is used to measure the efficiency of the on-line advertisement for a certain website or email campaigns.

OTT (over-the-top) are services, which are available for usage in the Internet and which are not proposed by the network operator. For example, Viber, Messenger, WhatsApp etc.

PUSH is one of methods for spreading the information or content in the Internet, when the data comes from the server to the user based on parameters set in a mobile application or WEB. In turn, the user either declines or accepts the data.

A detailed report regarding CDR calls (Call Detail Record) is a file or data created by a phone commutator or another telephony equipment, which fix attributes or a phone call or communication attempts (e.g., SMS message) that has passed through this equipment. The report comprises the following information: a timing, a completion status, numbers of initial and end subscribers.

HLR (Home Location Register) is a database that stores an information regarding each end user of the cellular communication network. The HLR stores the following information regarding the status of the services associated with the defined SIM card: a phone number (MSISDN) of the subscriber, GSM services available to the user, a location of the user (VLR or SGSN), readdressing settings.

VLR (Visitors Location Register) is a temporary database of subscribers, which are located within an operating area of a certain mobile commutation center. Each base station in the network is assigned to a certain VLR, thus, the subscriber cannot be present in several VLRs simultaneously.

SGSN (Serving GPRS Support Node) is a node for servicing the GPRS subscribers that is a main component of the GPRS system for implementing all functions of processing a packet information and executes the following functions: controlling a delivery of data packets to the users; interacting with a register of inherent subscribers of the HLR network or authenticating (checking for an approval for requesting the service by the users); monitoring users, which are on-line; transforming GSM frames into formats, which are used by the TCP/IP protocols of the wide area network Internet; registering subscribers, which “appeared” again within the coverage area of the network; encrypting data etc.

IP (Internet Protocol) is a routed network level protocol of the TCP/IP suite with a network addressing (IP address) being a mandatory part thereof.

TCP (Transmission Control Protocol) is a protocol for operating the data transmission within computer networks having the established connection, thereby providing a reliable delivery of the data from a host-sender to a host-recipient, for which a logical association between the hosts is established.

Host is any computer device that has access to the IP of the network.

API (Application Programming Interface) is a set of definitions of routines, interaction protocols, and means for software creation. In other words, the API is a set of precisely defined methods for interaction between various components. The API provides a developer with means for quick software development and may be used for web-based systems, operation systems, databases, hardware, software libraries etc.

Targeting (including an advertisement targeting) is an advertising mechanism that enables to directly select those portion from the overall present audience that meets the established criteria (a target audience), and to demonstrate the advertisement thereto precisely.

### PRIOR ART

It is impossible to imagine life of the modern society without advertisement that is one of the most dynamic fields of human activity that is able to transform rapidly. Therewith, first of all, advertisers concentrate their efforts on those fields, in which activity of users is the highest, thereby enabling to cover a maximum number of people with an information regarding advertising goods and services. Nowadays, traditional and the most widespread advertisement directions are mass media such as press, television, radio, subscription-based services, commonly available catalogs, web sites, billboards etc.

Along with said traditional usage fields of the advertisement, mobile communication means (a mobile phone and other devices) increasingly gain interest from advertisers, the means are not only devices for making phone calls, but frequently used for sending and receiving SMS messages. These messages created outside may include news, weather, sports, chat, financial messages, and links to another content, video games, ring melodies or multimedia content in response to a direct request by an end user, or they may be a result of his/her subscription to any of the above-mentioned services. With the appearance of such messages on the mobile devices and with the appearance of a large number of the mobile devices per se, which are used worldwide, huge marketing possibilities are opened for advertisers. Since operators are in a direct contact with the mobile communication subscribers, they are able to collect information regarding subscribers both by direct and indirect methods, the information includes their residence, age, sex, profession, financial capacities, interests etc. According to these criteria, advertisement campaigns may be created in order to provide the most efficient delivery of the information regarding goods and services to different groups of subscribers (a so-called targeted advertisement). Such approach is a mutually beneficial for all participants of the process and, first of all, for the subscribers, since it leads to reduction of costs for using the mobile communication services, eliminates an unnecessary advertisement, and provides the subscribers with an information about a matter that could be really interesting for them.

Thus, the Applicant is aware of several advertising solutions related to addition of an advertising text to SMS messages. Up until recently, a possibility of adding text messages to transactional SMS messages associated with a payment was being implemented within the Qiwi info payment system on the territory of the Russian Federation. A drawback of such solution is a limitation of its implementation exclusively within usage of the Qiwi payment terminals.

The mobile communication operator Lifecell Ukraine (MNO) Ltd. implements an advertising solution with text messages being added to a transactional SMS traffic, and its drawback is a limitation of its usage exclusively within the Lifecell traffic, as well as lack of a possibility of addition of a link to a personal microsite.

The prior art also teaches a method for providing an advertisement to users of telecommunication networks of cellular communications of a GSM/3G format by means of a telecommunication system, the method comprises adding an advertising text to the A2P message with an information regarding an account balance that is received by the user in response to a USSD-request after termination of a call, wherein the advertising message is selected with consideration of characteristics of the user profile and requirements of an advertiser, as disclosed in pat. EA024304B1 dated Sep. 30, 2016. A drawback of such technical solution is a limitation of its usage field, since it relates to messages, which are generated exclusively for users of a network of a specific mobile operator, and it does not enable to use a transactional traffic of any company and to cooperate with a large number of advertisers, for example, by means of an advertising exchange.

A similar method for adding an advertising text to SMS messages, which are received by a user from a mobile operator after a USSD request is made, is described in the application for an invention EA201201147A1 dated Nov. 29, 2013. As in the previous case, a drawback of the described technical solution is a limitation of its usage field, since it relates to messages, which are generated exclusively for users of a network of a specific mobile operator, and it does not enable to use a transactional traffic of any company and to cooperate with a large number of advertisers, for example, by means of an advertising exchange. Furthermore, making the USSD requests from the side of the subscribers to the mobile operator network causes additional inconveniences for the user, since an algorithm of actions of the user when sending the USSD requests may be different depending on a company that sends the SMS message.

The pat. RU2446623C1 dated Mar. 27, 2012 discloses a method for providing a target advertisement based on a data about a phone number of a subscriber that makes a call and a data about a phone number which the subscriber makes the call to, wherein the latter is checked within the operator system for a presence of an advertising message for it from a registered legal or private entity that believes that its advertising message is a relevant type of activity of the registered legal or private entity, which possesses the number called by the subscriber, and if such advertising message is present, it is forwarded to the subscriber to his/her phone number in a form of a separate SMS or MMS message, or it is sent in a form of an electronic message. As in the previous case, a drawback of such technical solution is a limitation of its usage field, since it relates to messages, which are generated exclusively for users of a network of a specific mobile operator.

Patents GB2406996 B dated Dec. 20, 2006 and EP1625716 B1 dated Nov. 14, 2007 teach methods for transmitting message of an advertising nature by means of MMS messages. In order to implement the methods, an advertising text and images are added to the SMS message, the SMS message with the added advertising material is converted into the MMS message, and the modified MMS message is delivered to an end user. A drawback of the proposed technical solutions lies in that in order to deliver the advertisement in the form of text, images, and animation, MMS messages are used, which are available and modern at the moment of receiving the patents, but which are inferior to modern technologies for delivering an advertising information by means of a mobile Internet with a branched coverage network and using, for example, personalized microsites, while links thereto may be added to the SMS message, and which comprise the advertising information not only in the form of text or images (available for the MMS messages), but in the form of various audio-, video files etc.

The pat. GB2471500A dated Jan. 5, 2011 discloses a method and a system for delivering an advertising message to a mobile phone user by adding the same to a warning message from a financial institution to create a combined message and transmitting the latter in the form of a SMS or a MMS message to a mobile phone device through a mobile phone communication network. A content of the advertising message is selected depending on business relationships between the user and the financial institution, time, and location of the user, and it may comprise a phone number, a URL address or a map of an advertising object in the form of embedded links. A drawback of the proposed technical solution is a limitation of its usage exclusively by the messages from the financial institutions and in an impossibility of its usage by any companies, which are capable of sending a transactional traffic to the end user.

The application US2011106626A1 dated May 5, 2011 teaches a RTB technology (a real-time advertisement bidding) that is implemented within an advertisement marketplace system and used for real-time addition of one or more advertisements to a SMS or MMS message in order to provide an effective and targeted advertisement for users. A drawback of the proposed technical solution lies in that the bidding winners place the advertising information within mailings of the SMS and MMS messages not on a routine basis, but exclusively within conduction of mass events, for example, during championships of football, basketball, Super Bowl in USA etc., thereby reducing the efficiency of this technical solution from the economic point of view, since the transactional messages are generated on a daily basis and do not possess a seasonality, and the companies, by adding the advertisement to their SMS messages, may revert a portion of the costs spent for the transactional SMS traffic.

As the closest analogue of the group of inventions, the U.S. Pat. No. 7,930,208B2 dated Apr. 19, 2011 is taken, which discloses a method and a device for combining advertising messages with SMS and/or MMS messages within a wireless communication system by conducting real-time advertisement bidding (RTB). A node for processing and routing signal messages transmits and receives SMS and/or MMS data packets through a communication network. The routing node includes a module for processing SMS and/or MMS messages that determines whether the SMS and/or MMS message must be modified for inclusion of the advertisement. The modified or non-modified SMS and/or MMS messages are transmitted to a target mobile communication device. Therewith, the decision as to whether the SMS and/or MMS message must be modified for inclusion of the selected advertisement depends on the following factors: the message content and format, the advertisement content and format, communication characteristics and display of a mobile communication end device, restriction of a channel that is used for transmission of the message to the target mobile communication device. A drawback of the proposed technical solution lies in that the content modification occurs after it has been received by the SMS center, and the information regarding personal data of the end user received from the requests to HLR is not sufficient for the effective advertising targeting. Furthermore, the proposed technical solution implies use of a single-channel delivery of the traffic according to the SS7 protocol, which makes impossible use of such generally used and presently popular OTT channels as Viber, WhatsApp etc.

### SUMMARY

The group of inventions disclosed herein is based on a task to provide a highly reliable, economically feasible, and effective delivery of a personalized advertising content to users of mobile phones by means of adding the same to short A2P SMS messages.

A first aspect of the present embodiments provides a method for modifying a message in the SMS format by including a personalized advertising content therein, the method comprises:

receiving a primary SMS message from a sender company by means of a http/https request for adding an advertising message to the primary SMS message that is addressed to an end user and that is a transactional A2P message;

establishing a number of free characters in the primary SMS message and defining its coding scheme by identifying a language of its text and a size. Therewith, the primary SMS message may be received in XML, JSON, SMPP or SS7 formats, which remain non-modified during further transmission of the message;

sending a request and receiving a response by means of an API protocol to at least one of databases of an anonymized information regarding an end subscriber based on a phone number thereof. The anonymized information may relate to a country, a city, a district, where the end user is located, interests or categories of goods, which may be potentially interesting for him/her, etc.;

receiving the response by means of the API protocol from the at least one of the databases of the anonymized information;

finding such advertising messages in a database, which have a size that is equal or less than the number of the free characters in the primary message and meet the request's entrance criteria. The number of characters in the SMS message with the advertising text, according to some embodiments, cannot exceed 160 characters in Latin coding and 70 characters in Cyrillic coding. If it is not possible to modify the SMS message received from the company for any reasons, the received message will be delivered to the end user in its initial state;

comparing data of the found advertising messages with the data of the anonymized information regarding the end user;

selecting the advertising message that meets the entrance criteria. Therewith, the advertising message may comprise personalized advertising texts, an active URL address that leads to personalized microsites, a phone number or a short phone number etc.;

wherein the advertising message that meets the criteria and is present in the database of advertising messages is checked and/or the database is updated by means of sending a request to a platform of advertising messages (Advertisement Exchange) that conducts a real-time advertisement bidding and adds the advertising message that meets the request's criteria to the database;

defining a total number of characters in the primary message and in the selected advertising message, and modifying the primary message by adding the selected advertising message to its body;

transmitting the modified primary message to a destination subscriber through an infrastructure for the SMS message delivery and/or delivery channels according to those indicated in the http/https request from the sender company. Additional channels may be channels of OTT services (Viber, WhatsApp etc.), as well as PUSH notifications.

Therewith, the method further comprises creating texts of the advertising messages, mobile microsites, setting an advertisement targeting in the SMS message, and reviewing statistics on the website Web UI that comprises a database (Microsite storage), which stores ready mobile microsites, and a database with advertising texts (Database of texts) and that is bidirectionally coupled through a Server-side web API server protocol to a service for creating mobile micro-websites (Microsite builder). Due to the high personalization of the mobile microsites, characteristics of clicks via link in the advertising material (CTR) are increased significantly.

Therewith, the method further comprises monitoring an operability, availability, and operation stability of system services by means of a Monitoring module that notifies the corresponding authorities in case the service operability or any of its separate components is failed. Zabbix or an analogue that meets all the requirements regarding support and monitoring can be used as the module.

Therewith, the method further enables generating a statistical data regarding the received, processed, and sent SMS messages by means of a Statistics module having a main task of transmitting the data to other modules to display the data to the users of the service in a real time.

Therewith, the method further forms a data regarding sending of the SMS messages with the advertising materials by means of a CDR (Call data record) module, the data is further processed by means of a Billing platform.

A second aspect of the present disclosure provides a system for modifying a message in a SMS format by including a personalized advertising content therein, the system comprises:

a module (SMS filter DCS) for receiving a primary SMS message and a http/https request for adding an advertising message from an external device of a sender company and analyzing parameters of the primary SMS message, which represent a size, a number of used characters, a text language, in order to define a number of free characters. Therewith, the primary SMS message may be in XML, JSON, SMPP or SS7 formats, which remain non-modified during further transmission of the message;

a software (sending and receiving) interface for exchanging (Data partners API) http/https requests to databases of an anonymized information based on a phone number of a destination subscriber in order to define criteria of the personalized advertising content. Therewith, the databases of the anonymized information (Data Partners) may be a single or several databases of a traffic Donor (the one that sends messages to an end user) or databases of the advertising exchange that conducts a real-time advertisement bidding, or other databases of third-party companies. The anonymized information may relate to a country, a city, a district, where the end user is located, interests or categories of goods, which may be potentially interesting for him/her, etc.;

a database (Data Base) with the advertising messages that is coupled, by an exchange protocol, to a platform of advertising messages (Advertisement Exchange) that operates according to the Real-time-bidding technology and has databases, among which it selects the advertising message that meets the criteria based on the parameters of the primary SMS message and the defined criteria of the personalized advertising content. Therewith, the databases Advertisement Exchange include databases of partners (Data Partners) with an additional information about the end user that is used for the advertisement targeting; a database (Data storage) with an information about the advertisement targeting, a number of characters in the message, a winner of the real-time bidding, an information of a financial nature, statistics; a database of mobile web sites (Mobile ready website) and a database of advertising texts (Database of texts) with an information that is added to the SMS message;

a module for selecting a relevant advertising message for the primary SMS message in the database with the advertising messages, according to the defined criteria of the personalized advertising content received from the databases of the anonymized information based on the phone number of the destination subscriber. Therewith, the advertising message may comprise personalized advertising texts, an active URL address that guides to personalized microsites, a phone number or a short phone number etc.;

a module (Text insertion engine) for adding the selected advertising message to the primary SMS message, creating, and checking the modified message for the total number of characters; The number of characters in the SMS message with the advertising text, according to some of the disclosed embodiments, cannot exceed 160 characters in Latin coding and 70 characters in Cyrillic coding. If it is not possible to modify the SMS message received from the company for any reasons, the received message will be delivered to the end user in its initial state;

a routing node (Router) that is coupled to the analysis module (SMS filter DCS) and the addition module (Text insertion engine), configured to receive the SMS message from the analysis module (SMS filter DCS) or to receive the SMS message from the addition module (Text insertion engine), and to transmit the same to an infrastructure for the SMS delivery and/or to additional channels for delivering the message to the destination subscriber. Additional channels may be channels of OTT services (Viber, WhatsApp etc.), as well as PUSH notifications.

Therewith, the system may be further coupled via the Web API protocol to the Web UI website to enable creating texts of the advertising messages, mobile microsites, setting an advertisement targeting in the SMS message, reviewing statistics that comprises a database (Microsite storage), which stores ready mobile microsites, and a database with advertising texts (Database of texts) and that is bidirectionally coupled through a Server-side web API server protocol to a service for creating mobile micro-websites (Microsite builder). Due to the high personalization of the mobile microsites, characteristics of clicks via link in the advertising material (CTR) are increased significantly.

Therewith, the system further comprises a Monitoring module for monitoring an operability, availability, and operation stability of the its services and notifying the corresponding authorities in case the service operability or any of its separate components is failed. Zabbix or an analogue that meets all the requirements regarding support and monitoring can be used as the module.

Therewith, the system comprises a Statistics module for generating a statistical data regarding the received, processed, and sent SMS messages, the module having a main task of transmitting the data to other modules to display the data to the users of the service in real time.

Therewith, the system further comprises a module for forming data (CDR or Call Data Records) regarding sending of the SMS messages with the advertising materials, the data is further used to issue invoices for advertisers and companies that send the SMS messages by means of processing by the Billing platform.

A technical effect of the claimed group of inventions lies in an effective, quick, and reliable addition of the targeted advertisement to the original text of the A2P SMS messages, which are sent by enterprises, mobile operators, and HUBs to their end users using the real-time bidding technology (RTB) that enables the advertisers to distribute the personalized advertising content in an automatic and effective fashion.

### BRIEF DESCRIPTION OF THE DRAWING

An exemplary embodiment of the method and system, according to the group of inventions, is illustrated by the drawings, which show the following:

FIG. 1 illustrates elements of system for modifying the SMS A2P message by including the personalized advertising content therein.

FIG. 2 illustrates elements of the system for modifying the SMS A2P message by including the personalized advertising content therein, which implies receiving the aggregated A2P SMS traffic from HUBs and, upon addition of the advertising message to the initial SMS message, delivering the modified SMS message to the end user through the infrastructure for delivery of SMS messages.

FIG. 3 illustrates elements of the system for modifying the SMS A2P message by including the personalized advertising content therein, which implies receiving the aggregated A2P SMS traffic from HUBs and, upon addition of the advertising message to the initial SMS message, returning the modified SMS message to the HUB that delivers it to the end user.

FIG. 4 illustrates elements of the system for modifying the SMS A2P message by including the personalized advertising content therein, which utilizes the addition of the advertising message to the SMS message according to the request from the companies and/or mobile operators and/or HUBs through the API, afterwards, the modified message is returned back to the companies and/or mobile operators and/or HUBs.

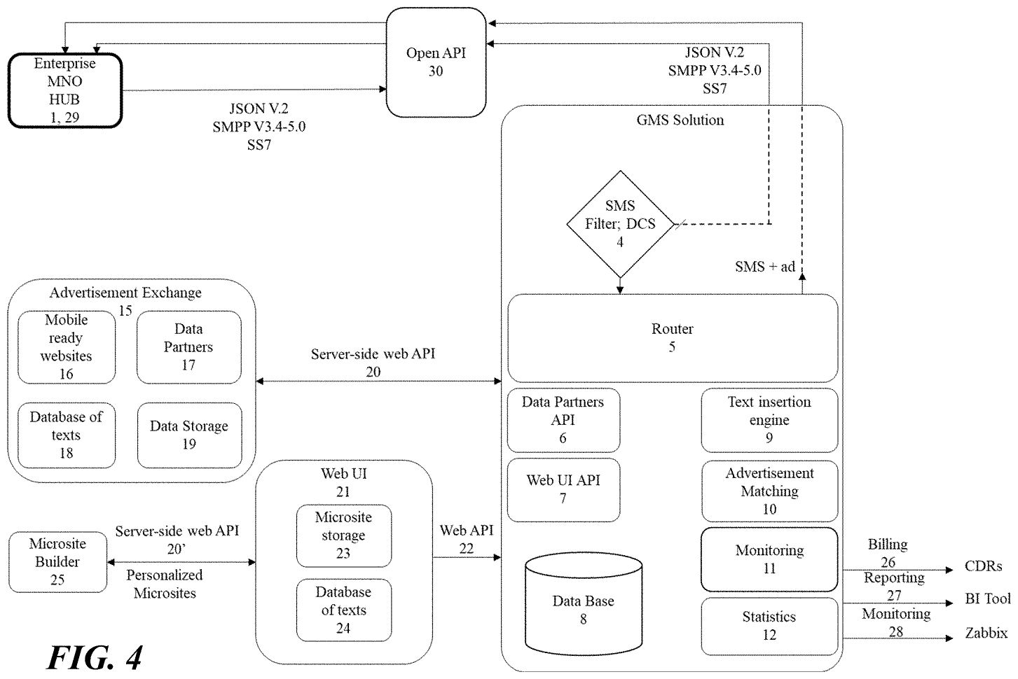

FIG. 5 illustrates an exemplary embodiment of the method for modifying the SMS A2P message by including the personalized advertising content therein.

FIG. 6 illustrates an exemplary embodiment of the method for modifying the SMS A2P message by including the personalized advertising content therein, wherein sending of the messages is performed through additional channels (other than SMS).

### MAIN DESIGNATIONS

1—Enterprise, MNO—the sender company (mobile communication enterprise or operator)
2—Load balancing—the system for balancing a load of the incoming SMS traffic
3—Buffer storage—the system for SMS distribution
4—SMS filter DCS—the module for analyzing the incoming SMS message
5—Router—the node for routing the SMS messages
6—Data partners API—a software (sending and receiving) interface for exchanging http/https requests to the databases of the anonymized information
7—Web UI API—the API protocol for transmitting data through the http requests between the Web UI and the system
8—Data base—the database with the advertising messages
9—Text insertion engine—the module for adding the selected advertising message to the initial SMS message
10—Advertisement matching—the module for selecting relevant advertising messages for the original SMS messages
11—Monitoring—the module for monitoring operability, availability, and stability of operation of the system services
12—Statistics—the module for generating statistics data regarding the received, processed, and sent SMS messages
13—SMS Platform—the platform for delivering SMS messages
14—the end user
15—Advertisement Exchange—the platform of advertising messages that operates according to the RTB technology
16—Mobile ready websites—the database of mobile web sites
17—Data Partners—the database of partners
18—Database of texts—the database of advertising texts
19—Data storage—the database with the information about targeting of the advertising messages, the number of characters in the message, winner of the real-time bidding, information of the financial nature, statistics etc.
20, 20′—Server-side web API—server protocols
21—Web UI—the web site
22—Web API—the web protocol
23—Microsite storage—the database of ready mobile microsites
24—Database of texts—the database with texts of the advertising messages
25—Microsite builder—the service for creating mobile microsites
26—Billing—a technical connection to the platform for processing CRDs data for issuing invoices to the advertisers and companies
27—Reporting—a technical connection to the on-line platform for forming and displaying reports and statistics of the operation of the system services
28—Monitoring—a technical connection to the system for monitoring, informing, tracking the operability, availability, and stability of the operation of the system services
29—HUB/Aggregator—the company that sends the traffic from other clients in transit.
30—Open API—the opened API protocol

### DETAILED DESCRIPTION OF THE PREFERRED EMBODIMENTS

The group of inventions is implemented in several embodiments according to the examples mentioned below.

### Example 1

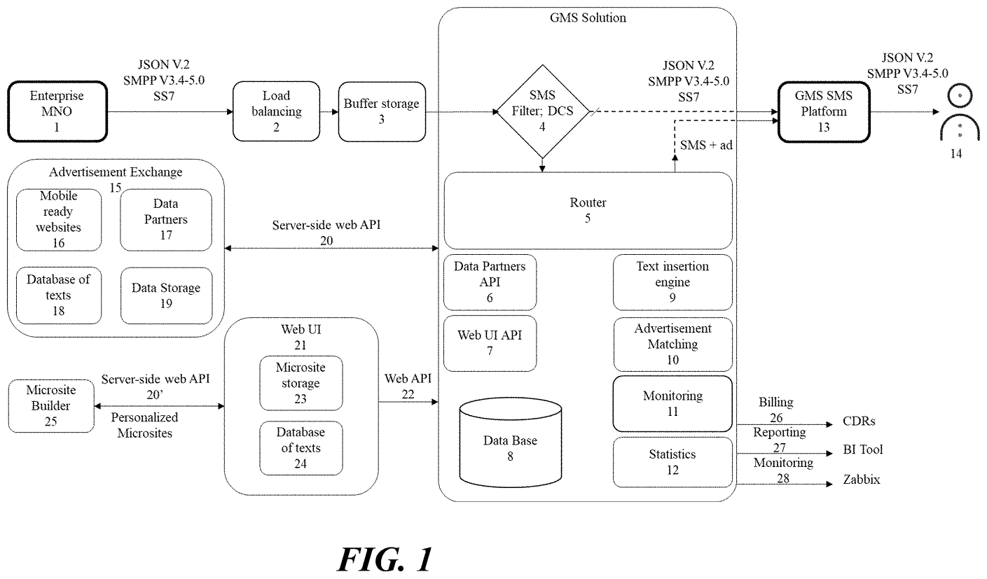

The system for modifying the SMS A2P message by including the personalized advertising content therein, which comprises the interconnected elements and implemented according to the scheme in FIG. 1:

The sender company (mobile communication enterprise or operator) 1 sends the transactional A2P SMS messages according to the currently known protocols, e.g., JSON, SMPP, XML, SS7 or any other one, through the system for balancing the load of the incoming SMS traffic (load balancing) 2 and the system for distributing SMS messages (Buffer storage) 3 to the module for receiving the initial SMS message and the http request for adding the advertising message from the external company device and analyzing the initial SMS message (SMS filter DCS) 4, wherein analysis of the initial message parameters occurs, which are size, number of the characters used, language of the text, in order to determine the number of free characters, that serves as a basis for determining a possibility of adding the advertising content to the initial SMS message. In case it is not possible to add the advertising content to the initial SMS message, it will be sent to the end user 14 through the platform 13 for delivering the SMS messages in the JSON, SMPP, XML or SS7 format without modifications. If the analysis indicates that it is possible to add the advertising content to the initial SMS message, it will be forwarded through the node for routing the SMS messages (Router) 5 to the software (sending and receiving) interface for exchanging (Data partners API) 6 the http/https requests to the databases of the anonymized information based on the phone number of the destination subscriber to determine the criteria of the personalized advertising content. The advertising messages, which are added to the initial SMS message, are comprised in the database with the advertising messages (Data Base) 8 associated by the server exchange protocol (Server-side web API) 20 to the platform of the advertising messages (Advertisement Exchange) 15 that operates according to the RTB technology and has databases of the mobile web sites (Mobile ready websites) 16, databases of partners (Data Partners) 17, databases of the advertising texts (Database of texts) 18, databases (Data storage) 19 with the information about targeting of the advertising messages, the number of characters in the message, winner of the real-time bidding, the information of the financial nature, statistics etc., among which, based on the parameters of the initial SMS message and the determined criteria of the personalized advertising content, the advertising message that meets the criteria is selected by means of the module for selecting the relevant advertising message (Advertisement matching) 10, afterwards, it is added to the initial SMS message by means of the module for adding the selected advertising message (Text insertion engine) 9, which also performs the additional check of the modified message for the total number of characters with consideration of the maximum acceptable DSC number of characters. If the modified message is divided into two and more, the advertising message will be removed, while the initial SMS message (with no advertisement) in the JSON, SMPP, XML or SS7 formats will be forwarded to the end user 14 through the platform for delivering the SMS messages (SMS Platform) 13. If the addition of the advertising message does not cause the division of the modified message into two or more, the modified message with the added advertisement in the JSON, SMPP, XML or SS7 formats will be forwarded from the module for adding the selected advertising message (Text insertion engine) 9 through the node for routing the SMS messages (Router) 5 and the platform for delivering the SMS messages (SMS Platform) 13 to the end user 14.

The system is further coupled via the Web API protocol 22 to the Web UI web site 21 to enable creating texts of the advertising messages, mobile microsites, setting an advertisement targeting in the SMS message, reviewing statistics that comprises a database (Microsite storage) 23, which stores ready mobile microsites, and a database with advertising texts (Database of texts) 24 and that is bidirectionally coupled through a Server-side web API server protocol 20′ to a service for creating mobile micro-websites (Microsite builder) 25.

The system further comprises the Monitoring module 11 for monitoring operability, availability, and stability of operation of services thereof, and the Statistics module 12 for generating the statistics data regarding the received, processed, and sent SMS messages that is further coupled to the module for forming data (CRD or Call Data Records) about sending of the SMS messages with the advertising materials, which are further used for issuing invoices to the advertisers and companies, which send the SMS messages, by means of processing by the Billing platform 26 and the platform for forming reports (Reporting) 27.

The system further comprises the technical connection to the systems for monitoring (28) operability, informing, availability, and stability of operation of the system services, as well as to the on-line platform (27) for forming and displaying reports and statistics on the operation of the system services, as well as to the platform for processing the CRDs data (26) for issuing invoices to the advertisers and companies.

### Example 2

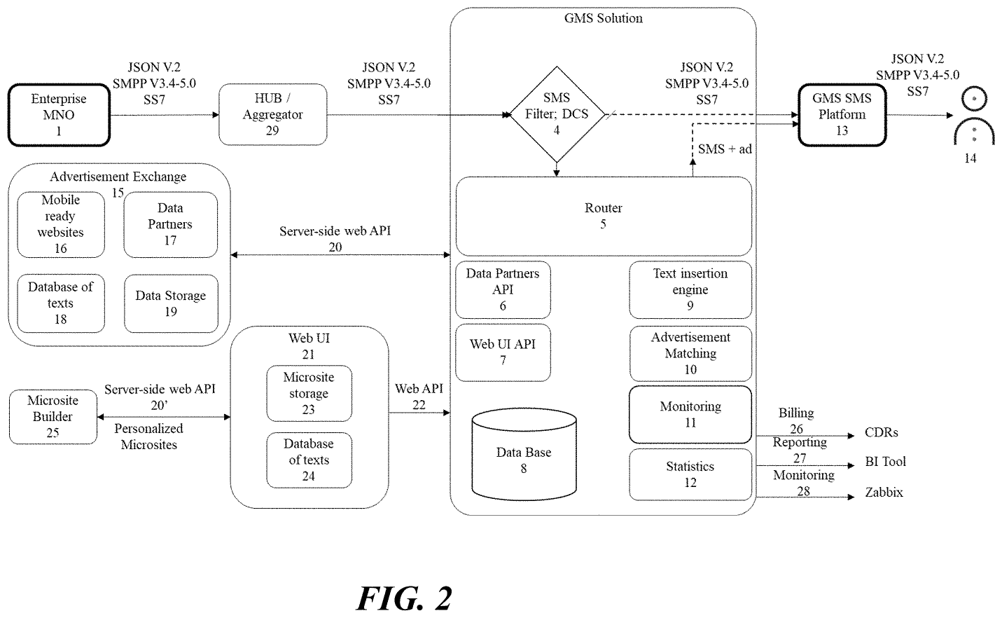

The system for modifying the A2P SMS message by including the personalized advertising content therein, which implies receiving the aggregated A2P SMS traffic from HUBS and, upon addition of the advertising message to the initial SMS message, delivering the modified SMS message to the end user through the infrastructure for delivery of SMS messages, which is implemented according to the scheme in FIG. 2.

The sender company (mobile communication enterprise or operator) 1 sends the transactional A2P SMS messages in the JSON, SMPP or SS7 formats to the HUB (HUB/Aggregator) 29, afterwards, it is received by the module for receiving the initial SMS message and the http request for adding the advertising message from the external device of the sender company and analyzing the initial SMS message (SMS filter DCS) 4. Next steps of the system implementation are identical to the steps described in the Example 1.

### Example 3

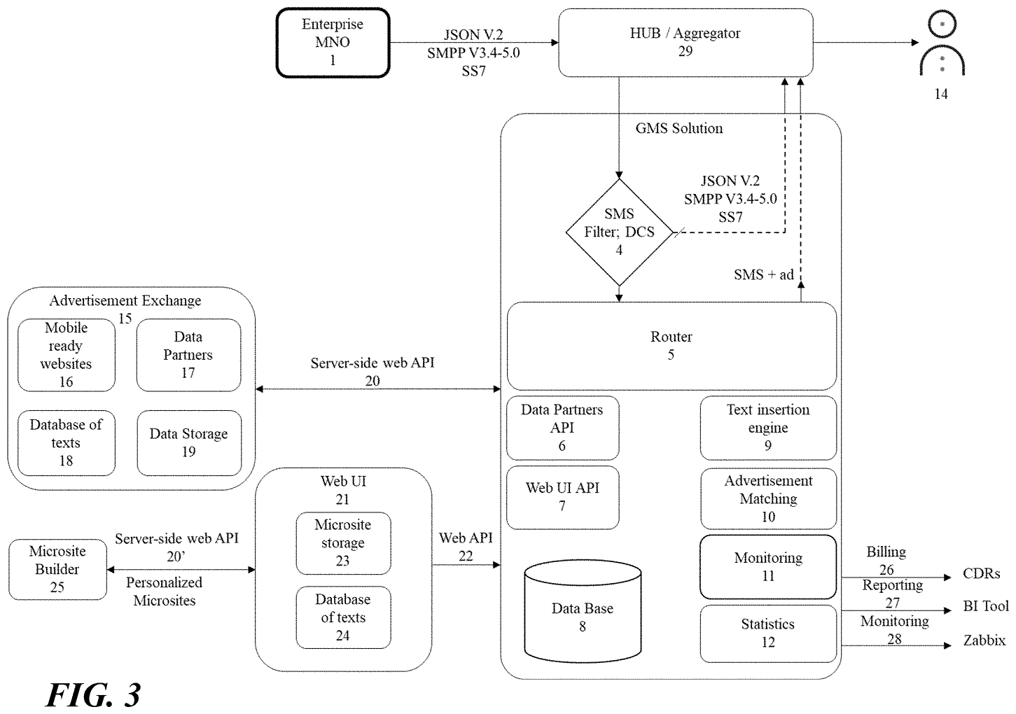

The system for modifying the SMS A2P message by including the personalized advertising content therein, which implies receiving the aggregated A2P SMS traffic from HUBs and, upon addition of the advertising message to the initial SMS message, returning the modified SMS message to the HUB that delivers the same to the end user, which is implemented according to the scheme in FIG. 3.

The sender company (mobile communication enterprise or operator) 1 sends the transactional A2P SMS messages in the JSON, SMPP, XML or SS7 formats to the HUB (HUB/Aggregator) 29, afterwards, it is received by the module for receiving the initial SMS message and the http request for adding the advertising message from the external device of the sender company and analyzing the initial SMS message (SMS filter DCS) 4. Next steps of the system implementation are identical to the steps described in the Example 1. The difference lies in that the modified message is returned to the HUB 29 that delivers the same to the end user 14.

### Example 4

The system for modifying the A2P SMS message by including the personalized advertising content therein, which utilizes the addition of the advertising message to the SMS message according to the request from the companies and/or mobile operators and/or HUBs through the API, afterwards, the modified message is returned back to the companies and/or mobile operators and/or HUBs.

The sender company (mobile communication enterprise or operator) 1 and/or the HUB 29 sends the transactional A2P SMS messages in the JSON, SMPP, XML or SS7 formats through the opened API protocol 30 to the module for receiving the initial SMS message and the http request for adding the advertising message from the external device of the sender company and analyzing the initial SMS message (SMS filter DCS) 4. Next steps of the system implementation are identical to the steps described in the Example 1. The difference lies in that the modified message is returned through the opened API protocol 30 to the sender company (mobile communication enterprise or operator) 1 and/or to the HUB 29.

### Example 5

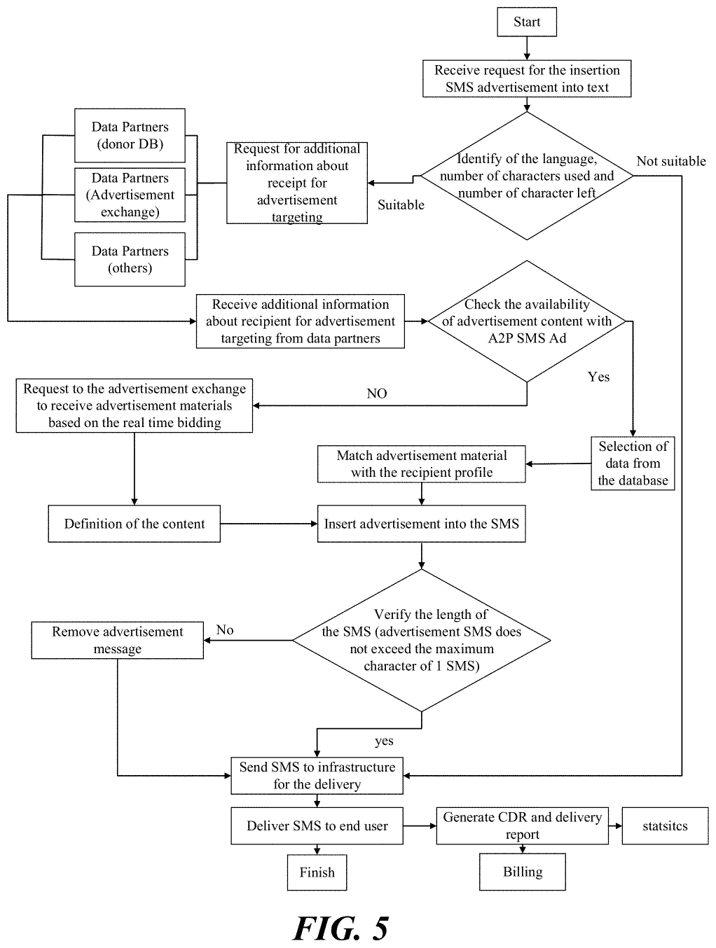

The method for modifying the A2P SMS message by including the personalized advertising content therein according to the scheme in FIG. 5.

According to the depicted scheme, the modification of the message in the SMS format by including the personalized advertising content therein starts from the receipt of the request for adding the advertising message to the initial SMS message from the company or mobile operator. The requests may be in the format of http/https requests, XML, JSON, SMPP or SS7, afterwards the language, number of characters of the initial SMS message, which are used and free from the potential advertisement, are determined. As it is known, the standard length of text messages constitutes 160, but use of the Unicode set of characters reduces this length up to 70 characters. Furthermore, spaces and hyphens are necessary for certain characters. These screening characters take two characters (14 bits) for coding. Thus, even if 160 characters are available, the message may be divided, if it comprises one of such symbols. At this step, based on the analysis of the message, it is determined whether such message is suitable for adding the advertising content or it must be sent to the end user with no changes. f it is determined that the message may be used for addition of the advertising content, the requests for the additional anonymized information about a recipient of the targeted advertisement will be made to the Data Partners, which may be a single or several databases of a traffic donor (the one that sends messages to an end user) or the database of the Advertising Exchange that conducts a real-time advertisement bidding, or other databases of third-party companies. Afterwards, the presence of the advertising messages from the advertisers, which are suitable to be added to the message text, is checked. If the advertising message is present, the request to the database with the advertising materials will be made. Based on the request to the database with the advertising materials and the anonymized information received from the Data Partners, the corresponding advertising materials are selected. If the advertising message that may be used for addition into the initial SMS message is absent in the databases, the system will refer to the Advertisement Exchange and transmit the additional information about the end user received from the Data Partners. Based on the enriched data, the Advertisement Exchange conducts the real-time bidding (RTB) and determines the winner. Upon determination of the bidding winner, the Advertisement Exchange refers to its internal databases, which store the preliminary prepared advertising materials. The advertising materials (the advertising message text, link, long and short number etc.) are added to the initial SMS message. Afterwards, the additional checking is made as to whether the modified SMS message with the added advertising messages does not exceed the maximum acceptable number of the DCS characters for one SMS message. If the message is divided into two and more after modification, the advertising materials will be removed. In this case, the end user will receive the original SMS message with no advertisement, while the company that sends the SMS messages and the company that provides the advertising messages will be informed about the reason why the advertisement was not added. If the modified SMS message is not divided into several messages, it will be sent to the infrastructure for delivering the SMS messages for further delivery to the end user. Based on the delivered/sent SMS messages, the Call Data Records (CRD) and reports regarding the delivery of the SMS messages are generated, which are transmitted to the statistics module. The CDRs are transmitted to the system for issuing invoices.

### Example 6

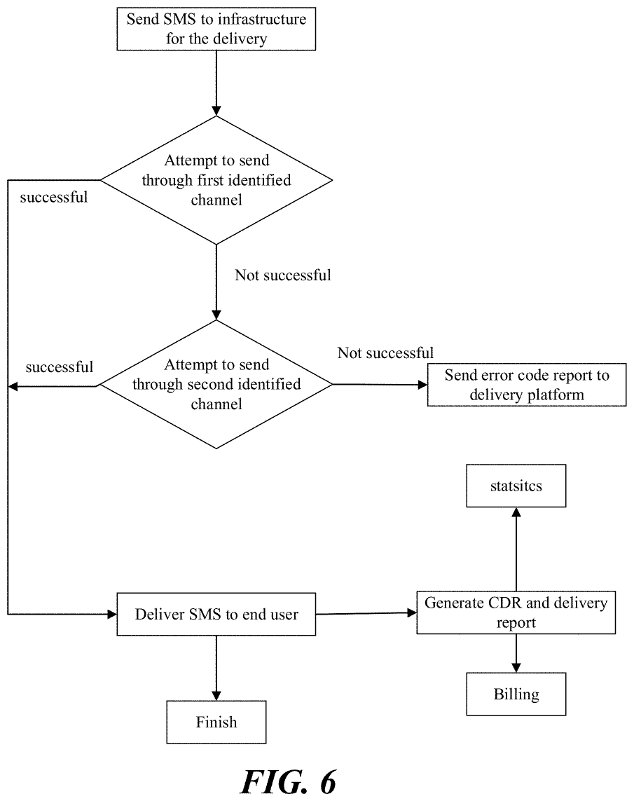

The method for modifying the A2P SMS message by including the personalized advertising content therein, wherein sending of the messages is performed through additional channels (other than SMS) is implemented according to the scheme in FIG. 6.

If the message was not delivered, and the company or the mobile operator that were sending the request for addition of the advertising content to the SMS message indicated that in case the SMS message is not delivered, the message must be delivered by means of other channels (PUSH, OTT (Viber, WhatsApp)), then such message will be transmitted according to the scheme in FIG. 6.

If other delivery channels, e.g., OTT (the first channel in FIG. 6), was indicated in the http/https request with the text of the SMS message, the non-delivered SMS message will be sent to the OTT channel. Therewith, the priority of the channel may be selected additionally.

If the PUSH was indicated apart from the SMS message and OTT communication channel, and the message was not delivered through the SMS message and OTT, such message will be sent to the end user in the form of the PUSH notification (the second channel in FIG. 6). Therewith, the priority of the channel may be selected additionally.

In case when the message was not delivered in any of the indicated channels (the first and the second channel), an error report will be formed and transmitted to the platform for delivering messages.

If the delivery of the message through the first or the second channels is successful, the end user will receive the modified message. Based on the delivered/sent SMS messages, the Call Data Records (CRD) and reports regarding the delivery of the SMS messages are generated, which are transmitted to the statistics module. The CDRs are transmitted to the system for issuing invoices.

What is claimed is:

1. A method for modifying a message in a SMS format by including a personalized advertising content therein, the method comprising:
receiving a primary SMS message from a sender company by means of a http/https request for adding an advertising message to the primary SMS message that is addressed to an end user and that is a transactional A2P message;
establishing a number of free characters in the primary SMS message and defining its coding scheme by identifying a language of its text and a size;
sending a request and receiving a response by means of an API protocol to at least one of databases of an anonymized information regarding an end subscriber based on a phone number thereof;
receiving the response by means of the API protocol from the at least one of the databases of the anonymized information;
finding such advertising messages in a database, which have a size that is equal or less than the number of the free characters in the primary message and meet the request's entrance criteria;
comparing data of the found advertising messages with data of the anonymized information regarding the end user;
selecting the advertising message that meets the entrance criteria;
wherein the advertising message that meets the criteria and is present in the database of advertising messages is checked and/or the database is updated by means of sending a request to a platform of advertising messages (Advertisement Exchange) that conducts a real-time advertisement bidding and adds the advertising message that meets the request's criteria to the database;
defining a total number of characters in the primary message and in the selected advertising message, and modifying the primary message by adding the selected advertising message to its body;
transmitting the modified primary message to a destination subscriber through an infrastructure for the SMS delivery and/or delivery channels according to those indicated in the http/https request from the sender company.

2. The method of claim 1 further comprising creating texts of the advertising messages, mobile microsites, setting an advertisement targeting in the SMS message and reviewing statistics on the website Web UI that also comprises such components as a database (Microsite storage), which stores ready mobile microsites and a database with advertising texts (Database of texts) and that is bidirectionally coupled through a Server-side web API server protocol to a service for creating mobile micro-websites (Microsite builder).

3. The method of claim 1, wherein the method further enables monitoring an operability, availability, and operation stability of system services by means of a Monitoring module and/or generating a statistical data regarding the received, processed, and sent SMS messages by means of a Statistics module.

4. The method of claim 1, wherein the method further forms a data regarding sending of the SMS messages with the advertising materials by means of a CDR (Call data record) module, the data is further processed by means of a Billing platform.

5. A system for modifying a message in a SMS format by including a personalized advertising content therein, the system comprising:
a module (SMS filter) for receiving a primary SMS message from an external device of a sender company and analyzing parameters of the primary SMS message (DC S), which represent a size, a number of used characters, a text language, in order to define a number of free characters;
a software (sending and receiving) interface for exchanging (Data partners API) http/https requests to databases of an anonymized information based on a phone number of a destination subscriber in order to define criteria of the personalized advertising content;
a database (Data Base) with the advertising messages that is coupled, by an exchange protocol, to a platform of advertising messages (Advertisement Exchange) that operates according to the Real-time-bidding technology and has databases, among which it selects the advertising message that meets the criteria based on the parameters of the primary SMS message and the defined criteria of the personalized advertising content;
a module for selecting a relevant advertising message (Advertisement matching) for the primary SMS message in the database with the advertising messages, according to the defined criteria of the personalized advertising content received from the databases of the anonymized information (Data Partners) or from the internal database with the advertising messages (Data Base) based on the phone number of the destination subscriber;
a module (Text insertion engine) for adding the selected advertising message to the primary SMS message, creating, and checking the modified message for the total number of characters;
a routing node (Router) that is coupled to the analysis module (SMS filter) and the addition module (Text insertion engine), configured to receive the SMS message from the analysis module (SMS filter) or to receive the SMS message from the addition module (Text insertion engine), and to transmit the same to an infrastructure for the SMS delivery and/or to additional channels for delivering the message to the destination subscriber in the modified form.

6. The system of claim 5, wherein the platform of advertising messages (Advertisement Exchange) comprises:
databases of partners (Data Partners) with an additional information regarding an end user that is used for an advertisement targeting;
a database (Data storage) with an information regarding a targeting of the advertising messages, a number of characters in the message, a real-time bidding winner, a financial information, statistics;
a database of mobile websites (Mobile ready website) and a database of advertising texts (Database of texts) with an information that is added to the SMS message.

7. The system of claim 5, wherein the Data Partners represents databases of a traffic donor and/or databases of advertising exchange and/or third party databases of partners.

8. The system of claim 5, wherein the system is further coupled through the Web API protocol to the website Web UI with a possibility of creating texts of the advertising messages, mobile micro-sites, setting an advertisement targeting in the SMS message, reviewing statistics, the website comprising a database being Microsite storage, which stores ready mobile microsites and a database with advertising texts (Database of texts) and that is bidirectionally coupled through a Server-side web API server protocol to a service for creating mobile micro-websites (Microsite builder).

9. The system of claim 5 further comprising a Monitoring module for monitoring an operability, availability, and operation stability of the system services and/or a Statistics module for generating a statistical data regarding the received, processed, and sent SMS messages.

10. The system of claim 5 further comprising a module for forming data (CDR, call data record) regarding sending of the SMS messages with the advertising materials, the data is processed by means of a Billing platform.
